(19) United States
(12) Patent Application Publication
(10) Pub. No.: US 2008/0177626 A1
(43) Pub. Date: Jul. 24, 2008

(54) SYSTEM AND METHOD FOR DETERMINING USER PREFERENCES IN A TELECOMMUNICATIONS NETWORK

(75) Inventor: Steven Duong Nguyen, Plano, TX (US)

Correspondence Address: FOGG & POWERS LLC, 10 SOUTH FIFTH STREET, SUITE 1000, MINNEAPOLIS, MN, 55402, US

(73) Assignee: Samsung Electronics Co., Ltd., Suwon-city (KR)

(21) Appl. No.: 11/626,063

(22) Filed: Jan. 23, 2007

(51) Int. Cl. H04M 3/42; G06Q 30/00; G06Q 99/00

(52) U.S. Cl. 705/14; 379/201.02; 705/1

(57) ABSTRACT

A system and method for determining user preferences in a telecommunications network are disclosed. As one example, a system for determining user preferences in a telecommunications network is disclosed. The system includes a first server configured to receive and store a plurality of user address books, a second server configured to store a plurality of business types, wherein each business type of the plurality of business types is associated with at least one of a telephone number, URL, and a name, and a third server coupled to the first server and the second server. The third server is configured to receive the plurality of user address books, extract the at least one of a telephone number, URL and name from each user address book of the plurality of user address books, associate the extracted at least one of a telephone number, URL and name with a business type of the plurality of business types, and create a plurality of user preferences.

### FIELD OF THE INVENTION

The invention is related to the telecommunications field, and particularly, but not exclusively, to a system and method for determining user preferences in a telecommunications network.

### BACKGROUND OF THE INVENTION

A network address book is an address book that is maintained on a telecommunications network and synchronized with a client's local address book. Essentially, the network address book becomes available to a user's/subscriber's/client's communication device, such as a mobile phone, soft-phone, Session Initiation Protocol (SIP) phone, landline phone or other communication device, after the user logs in to the network involved. For example, if a user logs in to a network using a mobile phone, the network synchronizes and updates the address book located on the mobile phone with the user's network address book. Similarly, for example, if a user logs in to a network from outside the local calling area (e.g., another country) using a desktop soft-phone, the network synchronizes the address book located on the soft-phone with the user's network address book. Consequently, if a user's communication device is lost or becomes inoperable, the user's valuable contact information is maintained on the network and not lost. The user can simply replace or repair the communication device, and the network will synchronize the address book on the new or repaired device with the user's network address book.

Notwithstanding the numerous advantages of network address books, a significant problem that exists is that there is no technique currently available for determining user preferences from conventional network address books. In this regard, it is often desirable for network administrators to be able to determine users' preferences for a number of reasons, such as, for example, targeted advertising. For example, if information in a user's network address book indicates the user's interest in golf, then golf-related advertising could be directed to that user. Evidently, targeted marketing has proven to be much more effective than mass marketing, because in targeted marketing the advertisements (e.g., ads, coupons, etc.) are sent directly to the potential targets of the marketing campaign. The targeted individuals are those deemed most likely to purchase the advertised products. Therefore, in order for network administrators (and/or sponsors willing to pay for advertising) to be able to target individuals for advertising purposes, a technique is needed for determining user preferences from network address books.

### SUMMARY OF THE INVENTION

In a first example embodiment, a system for determining user preferences in a telecommunications network is provided. The system includes a first server configured to receive and store a plurality of user address books, a second server configured to store a plurality of business types, wherein each business type of the plurality of business types is associated with at least one of a telephone number, URL, and a name, and a third server coupled to the first server and the second server. The third server is configured to receive the plurality of user address books, extract the at least one of a telephone number, URL and name from each user address book of the plurality of user address books, associate the extracted at least one of a telephone number, URL and name with a business type of the plurality of business types, and create a plurality of user preferences.

In a second example embodiment, a system for determining user preferences in a telecommunications network is provided. The system includes a plurality of communication devices, each communication device of the plurality of communication devices configured to create and store a local address book, a network processor unit coupled to each communication device of the plurality of communication devices, the network processor unit configured to create a network address book associated with the local address book, a directory processor unit configured to store information associated with a plurality of business types, and an application processor unit coupled to the network processor unit and the directory processor unit, wherein the application processor unit is configured to receive data associated with at least one network address book, determine business type information associated with the data, and determine a user preference associated with the business type information.

In a third example embodiment, a method for determining user preferences in a telecommunications network is provided. The method includes the steps of receiving a plurality of user address books, storing the plurality of user address books as a plurality of network address books, associating a plurality of business types with at least one of a telephone number, URL, and a name, storing the plurality of business types, retrieving the plurality of network address books, extracting at least one of a telephone number, URL and name from a network address book of the plurality of network address books, associating the extracted at least one of a telephone number, URL and name with a business type of the plurality of business types, and creating a plurality of user preferences responsive to the associating step.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an exemplary system for determining user preferences from one or more network address books, which can be used to implement an example embodiment of the present invention; and

FIG. 2 is a flowchart depicting an exemplary method for determining user preferences from one or more network address books, which can be used to implement an example embodiment of the present invention.

### DETAILED DESCRIPTION OF PREFERRED EMBODIMENT

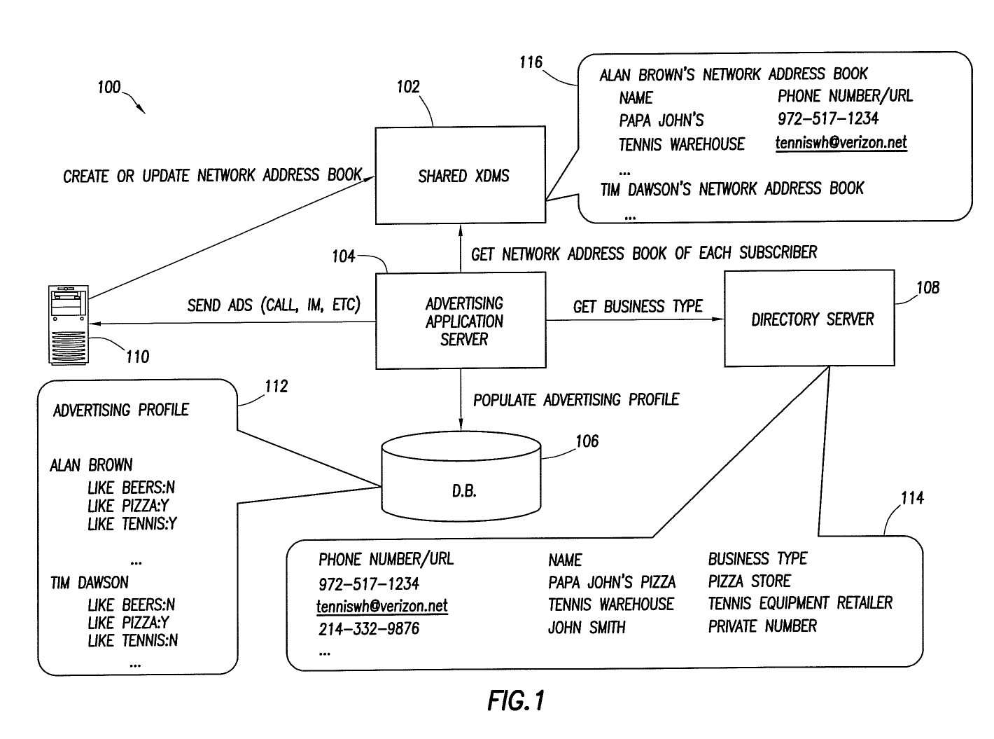

With reference now to the figures, FIG. 1 depicts a block diagram of an exemplary system 100 for determining user preferences from one or more network address books, which can be used to implement an example embodiment of the present invention. For this example embodiment, system 100 includes a shared Extended Markup Language (XML) Data Management Server (XDMS) 102. The shared XDMS 102 is a server that operates in accordance with the XML Configuration Access Protocol (XCAP), which is a Hyper-Text Transfer Protocol-based (HTTP-based) protocol that allows a client to read, write and modify application configuration data stored in an XML format on the server involved. The XML is a markup language that allows network designers to create their own customized tags. Specifically, for this example embodiment, the XML enables the definition, transmission, validation, and interpretation of data between applications and also between organizations. As such, the shared XDMS 102 is an XCAP server used to store and manage XML documents and provide document change notifications to subscribing entities. For this example embodiment, shared XDMS 102 can create, store and update a number of users' (e.g., subscribers', clients', etc.) network address books as XML documents. Examples of such network address books and their contents are shown in the block labeled 116. Also, shared XDMS 102 manages shared lists of users' names with associated phone numbers and/or Universal Resource Locators (URLs). These lists of users' names can be shared by different services, such as, for example, the Push-to-Talk or Instant Messaging (IM) services to name a few.

For this example embodiment, system 100 also includes an Advertising Application Server (AAS) 104 coupled to shared XDMS 102. An Application Server (AS) is a network server's computer, which is dedicated to running specific software applications. Generally, an AS can be implemented as a software engine, which is responsible for delivering applications to client computers or other network servers and/or computers. As such, for this example embodiment, AAS 104 is primarily responsible for creating (and populating with suitable data) a plurality of users' advertising profiles, and conveying specific advertisements to one or more targeted users. The AAS 104 is also responsible for conveying the created advertising profiles to a database 106. Database 106 is a network data storage medium, which stores the advertising profiles created by the AAS 104 for the users/subscribers involved. Examples of such advertising profiles and their contents are shown in the block labeled 112.

For this example embodiment, system 100 also includes a directory server 108 coupled to AAS 104. Generally, a directory server is a network server computer and storage medium, which is responsible for storing and managing user profiles, access privileges, and application and network resource information. For this example embodiment, directory server 108 is responsible for storing addressees' (e.g., businesses', acquaintances', family members', etc.) telephone numbers and/or URLs, along with associated business type information (e.g., pizza store, tennis equipment store, private number, etc.). Examples of such stored directory information are shown in the block labeled 114.

Also, for this example embodiment, system 100 includes a plurality of users' communication devices (e.g., indicated generally by a single handset) 110 coupled to shared XDMS 102 and AAS 104. Each communication device 110 may be implemented with a suitable communication device that is compatible with the type of network involved. For example, each user's communication device 110 may be implemented with a suitable mobile phone, cellular phone, soft-phone (e.g., software-based phone on a personal computer, etc.), desktop phone, wireless phone, wireline phone, SIP-based wireless or wireline phone, and the like. For this example embodiment, each communication device 110 can be implemented with a two-way communication device (or similar type of communication device) that can operate in accordance with the Internet Protocol (IP). In any event, each user's/subscriber's communication device 110 includes a storage medium that stores a local address book with pertinent information. When a user (e.g., subscriber) logs in to the network involved using a communication device 110, the network synchronizes the user's local address book with the user's network address book. This synchronization process updates the information in the local address book with the information contained in the network address book. A connection between each communication device 110 and shared XDMS 102 or AAS 104 can be made via a wireless link and/or a wireline link, and the type of connection made typically depends on the network interface involved.

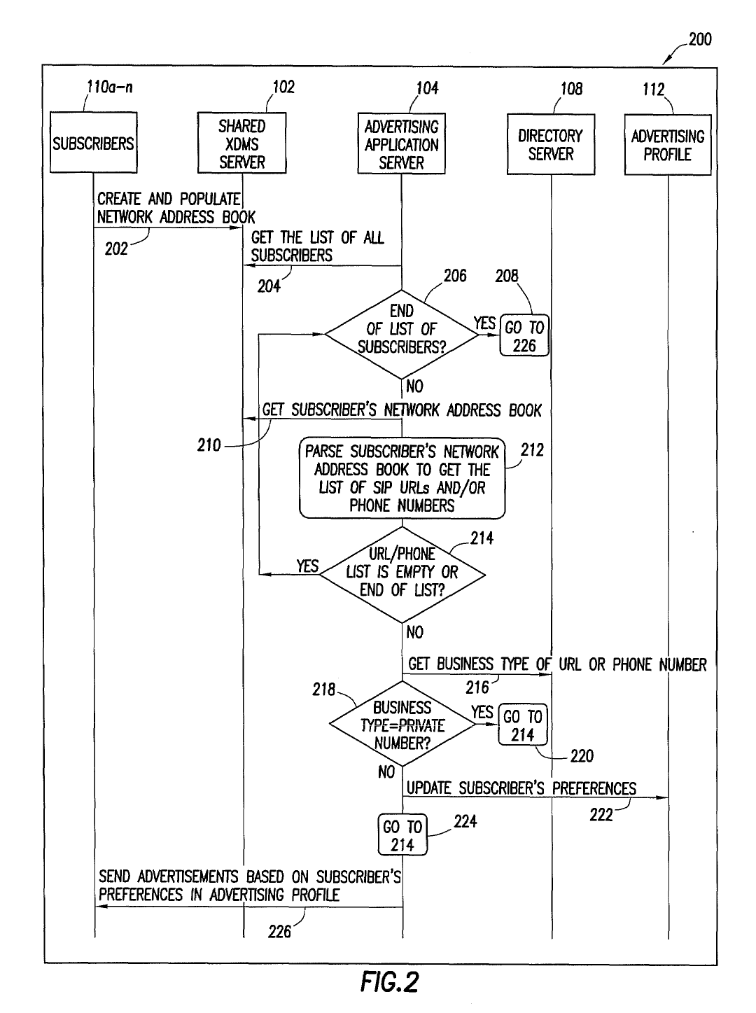

FIG. 2 is a flowchart depicting an exemplary method 200 for determining user preferences from one or more network address books, which can be used to implement an example embodiment of the present invention. For example, method 200 may be used to implement system 100 shown in FIG. 1. In this regard, for ease of understanding and illustrative purposes, like numerals in FIGS. 1 and 2 refer to like components.

Referring now to FIGS. 1 and 2 for this example embodiment, method 200 begins with each subscriber's (e.g., user's, client's, etc.) communication device 110a through 110n (where “n” represents the total number of communication devices) logging in to the network involved, and connecting to shared XDMS 102 (step 202). As part of this step, if a subscriber's communication device 110a through 110n contains a local address book, then the subscriber's local address book can be synchronized with the subscriber's network address book maintained, for this example, in shared XDMS 102. If the subscriber has made changes to the information in the local address book, then the synchronization process can update the subscriber's network address book with the changed and/or new information. However, if a subscriber does not have a network address book (e.g., new subscriber logging in for first time, existing subscriber creating a local address book for the first time, etc.), shared XDMS 102 can create a network address book for that subscriber, by receiving the pertinent information contained in the subscriber's local address book, creating a network address book storage location for that subscriber, and populating that network address book storage location with that subscriber's local address book information.

Next, for this example embodiment, AAS 104 requests and receives from shared XDMS 102 a sequential listing of the names of each of the subscribers to the network involved (step 204). AAS 104 then determines whether or not the subscriber's name being received is the final name in the list (step 206). If AAS 104 determines that the name being received is the final name in the list, then (at step 208) the flow proceeds to step 226. Returning to step 206, if AAS 104 determines that the subscriber's name being received is not the final name in the list, then AAS 104 requests and receives from shared XDMS 102 that subscriber's network address book and its contents (step 210). Again, an example of such a network address book and its contents is shown in the block labeled 116.

Next, AAS 104 parses the content in that subscriber's network address book (e.g., an XML document), and retrieves a list of the URLs and/or telephone numbers for the names contained in that network address book (step 212). For example, one or more of the URLs in a network address book might be obtained from a SIP meeting request, or the URL can be a typical URL provided by the addressee. AAS 104 then determines whether or not the received URL/phone list is empty, or the URL or phone number received is the final entry (URL or phone n-umber) in the list (step 214). If AAS 104 determines that the received URL/phone list is empty, or the URL or phone number received is the final entry (URL or phone number) in the list, then the flow returns to step 206. However, at step 214, if AAS 104 determines that the received URL/phone list is not empty, and/or the URL or phone number received is not the final entry in the list, then the flow continues to step 216.

At step 216, for that URL or phone number derived from the list, AAS 104 retrieves from directory server 108 a business type associated with that URL or phone number. Examples of such business type information are shown in the block labeled 114. Next, AAS 104 determines whether or not that URL or phone number includes a business type for a private or non-commercial addressee (step 218). For example, for targeted marketing applications, AAS 104 may disregard business type information for an entry that includes a private or non-commercial addressee's URL or phone number. If (at step 218) AAS 104 determines that the URL or phone number includes a business type for a private or non-commercial addressee, then the flow returns to step 214 (step 220). However, if AAS 104 determines that the URL or phone number includes a business type for a commercial addressee, then AAS 104 sends a suitable message to database 106, which includes the business type information retrieved for that URL or phone number, in order to update that subscriber's advertising profile 112 with the new business type information (step 222). The flow then returns to step 214 (step 224).

Note that although steps 204 through 224 in FIG. 2 are performed directly after step 202 in this example embodiment, in a different embodiment, steps 204 through 224 may be performed at a separate time from that of step 202. For example, steps 204 through 224 may be performed as part of a batch job that is run periodically (e.g., once a week, once a month, etc.).

Returning to method 200 in FIG. 2, for this example embodiment, AAS 104 sends one or more advertisements for targeted subscribers/users to a subscriber's communication device 110 (step 226). Notably, this step may be performed at any suitable point in time, and does not have to be performed directly after all of the subscribers' advertising profiles have been updated in step 222. For example, step 226 could be performed when a sponsor wants to begin an advertising campaign. Also, step 226 can be performed in a number of different ways. For example, AAS 104 (or XDMS 102) can send a suitable wireless message (e.g., Short Message Service or SMS message), a Multimedia Messaging Service (MMS) message, or an IM including the advertisement data to communication device 110. As another example, a subscriber's preferences can be combined with the subscriber's location information (e.g., currently located on a highway, in a mall, at home, etc.) and the subscriber's presence state (e.g., currently attending a meeting, available, not to be disturbed, etc.), in order to increase the chances that the advertisements will reach their intended recipients (targeted users) successfully.

Notably, in another embodiment, instead of storing subscribers' network address books on a shared XDMS as XML documents, system 100 can store the subscribers' network address books in any suitable database. For example, the network address book database can reside on any suitable network server. Also, in yet another embodiment, AAS 104 can be co-located with directory server 108 and/or with any other suitable application server. Also, in still another embodiment, in addition to using the information contained in the network address books to populate the subscribers' preferences, AAS 104 can retrieve subscribers' telephone calling pattern information from the subscribers' Call Detail Records (CDRs), and populate the subscribers' advertising profiles with the retrieved CDR information. AAS 104 may obtain the CDR information from a telephone network's call server. For example, assume that the business name “Pizza Hut” is not stored by a subscriber in the network address book, but the subscriber's CDRs indicate that the subscriber places numerous phone calls to a “Pizza Hut” store each week. Thus, AAS 104 can deduce from the subscriber's CDRs that the subscriber likes to eat pizza.

Notably, the present invention provides a system and method for determining user preferences in a telecommunications network, which can provide numerous benefits for the parties involved. For example, a service provider may benefit financially, by selling targeted marketing information to an advertising company. The advertising company may own and/or operate the AAS. In turn, the advertising company may benefit financially by charging sponsors for the costs (plus profit) of performing the targeted marketing. In turn, the sponsors may benefit financially from an increase in their sales volumes. Additionally, the subscribers may benefit from the convenience of receiving advertisements (e.g., ads, coupons, etc.) for products they appear to be interested in purchasing.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for determining user preferences in a telecommunications network, comprising:
a first server configured to receive and store a plurality of user address books;
a second server configured to store a plurality of business types, wherein each business type of the plurality of business types is associated with at least one of a telephone number, URL, and a name; and
a third server coupled to the first server and the second server, the third server configured to receive the plurality of user address books, extract the at least one of a telephone number, URL and name from each user address book of the plurality of user address books, associate the extracted at least one of a telephone number, URL and name with a business type of the plurality of business types, and create a plurality of user preferences.

2. The system of claim 1, further comprising:
a plurality of communication devices coupled to the first server, each communication device of the plurality of communication devices configured to create and store a local address book, and synchronize the local address book with an associated user address book of the plurality of user address books.

3. The system of claim 1, further comprising:
a plurality of communication devices coupled to the third server, each communication device of the plurality of communication devices configured to receive information associated with the plurality of user preferences.

4. The system of claim 1, further comprising:
a data storage medium coupled to the third server, the data storage medium configured to store the plurality of user preferences as a plurality of user preference profiles.

5. The system of claim 1, wherein the plurality of user address books comprises a plurality of XML documents.

6. The system of claim 1, wherein the first server comprises a shared XDMS.

7. The system of claim 1, wherein the second server comprises a network directory server.

8. The system of claim 1, wherein the third server comprises an Application Server.

9. The system of claim 1, wherein the third server comprises an Advertising Application Server, and the plurality of user preferences comprises an advertising profile.

10. The system of claim 1, further comprising a plurality of communication devices coupled to the third server, each communication device of the plurality of communication devices configured to receive from the third server advertising information associated with an advertising profile.

11. A system for determining user preferences in a telecommunications network, comprising:
a plurality of communication devices, each communication device of the plurality of communication devices configured to create and store a local address book;
a network processor unit coupled to each communication device of the plurality of communication devices, the network processor unit configured to create a network address book associated with the local address book;
a directory processor unit configured to store information associated with a plurality of business types; and
an application processor unit coupled to the network processor unit and the directory processor unit, wherein the application processor unit is configured to receive data associated with at least one network address book, determine business type information associated with the data, and determine a user preference associated with the business type information.

12. The system of claim 11, wherein the plurality of communication devices comprises at least one of a wireless telephone, radiotelephone, cellular phone, wireline telephone, SIP telephone, desktop telephone, and a soft-phone.

13. The system of claim 11, wherein the network processor unit comprises a shared XDM server.

14. The system of claim 11, wherein the application processor unit comprises an Advertising Application Processor (AAS).

15. The system of claim 11, wherein the application processor unit is further configured to convey at least one advertisement to at least one communication device of the plurality of communication devices.

16. The system of claim 11, wherein application processor unit is further configured to convey at least one advertisement to at least one communication device of the plurality of communication devices in at least one of a telephone call, Instant Message (IM), Multi-Media Service (MMS) message, and email message.

17. A method for determining user preferences in a telecommunications network, comprising the steps of:
receiving a plurality of user address books;
storing the plurality of user address books as a plurality of network address books;
associating a plurality of business types with at least one of a telephone number, URL, and a name;
storing the plurality of business types;
retrieving the plurality of network address books;
extracting at least one of a telephone number, URL and name from a network address book of the plurality of network address books;
associating the extracted at least one of a telephone number, URL and name with a business type of the plurality of business types; and
creating a plurality of user preferences responsive to the associating step.

18. The method of claim 17, further comprising the step of storing the plurality of user preferences as a plurality of user preference profiles.

19. The method of claim 17, further comprising the step of storing the plurality of user preferences as an advertising profile.

20. The method of claim 17, wherein the plurality of user preferences comprises at least one user's name and a list of commercial preferences associated with the at least one user's name.
